(19) United States
(12) Patent Application Publication
(10) Pub. No.: US 2016/0008853 A1
(43) Pub. Date: Jan. 14, 2016

(54) SORTING APPARATUS AND GENERATING METHOD OF SORTING SETTING INFORMATION

(71) Applicant: Kabushiki Kaisha Toshiba, Tokyo (JP)

(72) Inventor: Yohei Murayama, Kawasaki (JP)

(21) Appl. No.: 14/619,303

(22) Filed: Feb. 11, 2015

(30) Foreign Application Priority Data
Feb. 12, 2014 (JP) 2014-024724

(51) Int. Cl. B07C 3/00; B07C 5/34

(52) U.S. Cl. CPC B07C 3/006; B07C 5/34

(57) ABSTRACT

According to an embodiment, a sorting apparatus has a first generation section, a second generation section, a discrimination section, and a sorting section. The first generation section generates sorting result in which paper sheets have been sorted in a plurality of stackers in a prescribed order, by a two-pass sorting processing of result data indicating the numbers of past processing for respective sorting information. The second generation section generates setting information of a sorting processing of a first pass using the sorting result generated by the first generation section. The discrimination section discriminates the sorting information of the paper sheets to be processed. The sorting section sorts the paper sheets whose sorting information has been discriminated by the discrimination section, in accordance with the setting information of the sorting processing of the first pass.

### CROSS-REFERENCE TO RELATED APPLICATION

This application is based upon and claims the benefit of priority from the prior Japanese Patent Application No. 2014-024724, filed on Feb. 12, 2014, the entire contents of which are incorporated herein by reference.

### FIELD

Embodiments of the present invention relate to a sorting apparatus and a generating method of sorting setting information.

### BACKGROUND

Conventionally, in sorting apparatuses having a plurality of stackers, there is a sorting apparatus which rearranges a plurality of paper sheets in a prescribed order by a two-pass sorting processing. In the state that sorting information of the whole paper sheets to be processed is not determined (a sorting processing of a first pass, for example), the numbers of paper sheets stacked in respective stackers cannot be determined. If the sorting information is not determined, there is a possibility that a specific stacker may overflow.

A sorting apparatus is desired which can make setting for efficiently performing the sorting processing even when the sorting information of paper sheets to be processed is not determined.

### BRIEF DESCRIPTION OF THE DRAWINGS

FIG. 1 is a diagram showing a schematic configuration of a sorting apparatus according to an embodiment.

FIG. 2 is a flow chart for explaining an example of operation of the sorting apparatus according to the embodiment.

FIG. 3 is a flow chart for explaining an example of a generation processing of a first pass face and a second pass face in the sorting apparatus according to the embodiment.

FIG. 4 is a flow chart for explaining an example of a generation processing of the first pass face and the second pass face in the sorting apparatus according to the embodiment.

FIG. 5A and FIG. 5B are a flow chart for explaining an example of a generation processing of the first pass face and the second pass face in the sorting apparatus according to the embodiment.

FIG. 6 is a diagram showing an example of management data of the sorting apparatus according to the embodiment.

FIG. 7 is a diagram showing an example of original data of the second pass face of the sorting apparatus according to the embodiment.

FIG. 8 is a diagram showing an example in which the original data of the second pass face shown in FIG. 7 has been updated.

FIG. 9 is an example of result data.

FIG. 10 is an example in which a delivery person is added to the result data of FIG. 9.

FIG. 11 is a diagram showing an example of a data table of the first pass face and the second pass face.

FIG. 12 is a diagram showing an example in which FIG. 11 has been updated according to the addition of a stacker of the first pass.

FIG. 13 is a diagram showing an example in which FIG. 12 has been updated by the recalculation of the assignment of a stacker of the second pass.

FIG. 14 is a diagram showing an example of the first pass face which has been set using the data table of FIG. 13.

FIG. 15 is a diagram showing a setting example of the first pass face.

FIG. 16 is a diagram showing a setting example of the first pass face.

FIG. 17 is a diagram showing a setting example of the first pass face.

FIG. 18 is a diagram showing a setting example of the first pass face.

FIG. 19 is a diagram showing a setting example of the first pass face.

FIG. 20 is a diagram showing a setting example of the first pass face.

FIG. 21 is a diagram showing a setting example of the first pass face.

FIG. 22 is a diagram showing a setting example of the first pass face.

FIG. 23 is a diagram showing a setting example of the first pass face.

FIG. 24 is a diagram showing a setting example of the first pass face.

FIG. 25 is a diagram showing a setting example of the first pass face.

FIG. 26 is a diagram showing a setting example of the first pass face.

FIG. 27 is a diagram showing a setting example of the first pass face.

FIG. 28 is a diagram showing a setting example of the first pass face.

FIG. 29 is a diagram showing a setting example of the first pass face.

FIG. 30 is a diagram showing a setting example of the first pass face.

FIG. 31 is a diagram showing a setting example of the first pass face.

FIG. 32 is a diagram showing a setting example of the first pass face.

FIG. 33 is a diagram showing a setting example of the first pass face.

### EMBODIMENT TO PRACTICE THE INVENTION

According to an embodiment, a sorting apparatus has first generation means, second generation means, a discrimination section, and a sorting section. The first generation means generates sorting result in which paper sheets have been sorted in a plurality of stackers in a prescribed order, by a two-pass sorting processing of result data indicating past processing numbers for respective sorting information. The second generation means generates setting information of a sorting processing of a first pass using the sorting result generated by the first generation means. The discrimination section discriminates the sorting information of the paper sheets to be processed. The sorting section sorts the paper sheets whose sorting information has been discriminated by the discrimination section, in accordance with the setting information of the sorting processing of the first pass.

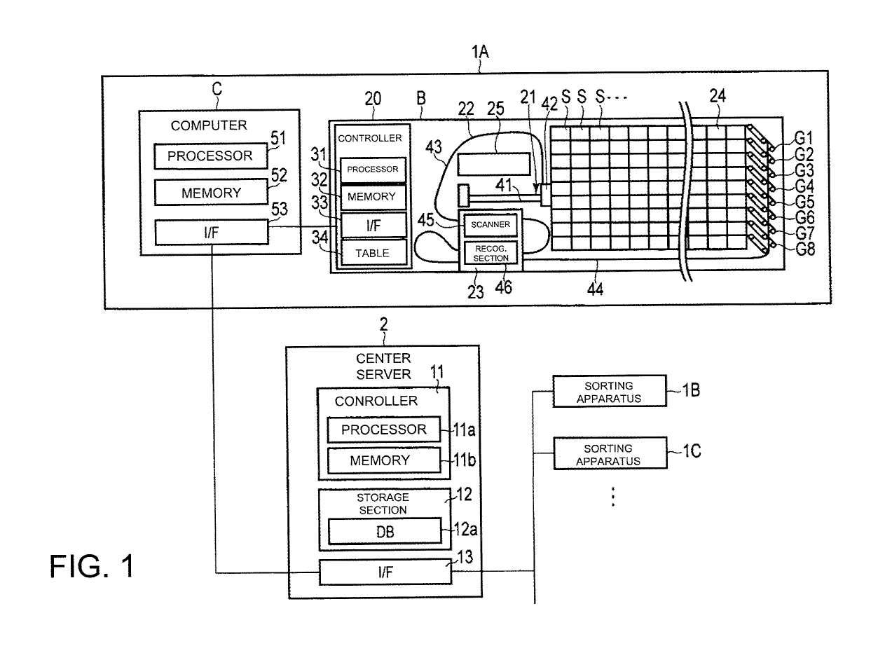

Hereinafter, an embodiment will be described with reference to the drawings. FIG. 1 schematically shows a configuration example of the whole of a network system including a sorting apparatus 1. The sorting apparatus 1 of the embodiment is used as a paper sheet processing apparatus. The sorting apparatus 1 (1A, 1B, . . . ) according to the present embodiment sorts an article to be sorted based on sorting information. The article to be sorted is a delivery article, such as a paper sheet or an article, and the sorting information is address information, for example. The sorting apparatus 1 according to the present embodiment and the network system are applied to a system for sorting a paper sheet such as a postal matter provided with address information, for example.

In the present embodiment, the sorting apparatus 1 (1A, 1B, . . . ) which sorts a paper sheet based on address information as the sorting information will be described. The address information as the sorting information is information to specify each delivery destination, and the whole information for sorting the articles to be sorted in the order of delivery. The address information is composed of number information of a prescribed number of digits (six digits, seven digits, for example) such as a postal code, and information composed of a plurality of hierarchies after the number information.

As shown in FIG. 1, a network system including a plurality of the sorting apparatuses 1 includes the plurality of sorting apparatuses 1, and a center server 2 connected to each of the sorting apparatuses 1. That is, each of the sorting apparatuses 1 (1A, 1B, . . . ) is connected to the center server 2 via a network. The center server 2 manages information in each of the sorting apparatuses 1. For example, the center server 2 collects sorting processing data, such as sorting processing result (processing history information) including sorting information and so on processed by each of the sorting apparatuses 1, via a network. The center server 2 stores the collected sorting processing data in a data base, and thereby manages data relating to the sorting processing in the whole system.

The center server 2 has a controller 11, a memory section 12 and an interface (I/F) 13. The controller 11 has a processor 11a, a memory 11b and various internal interfaces and so on. The processor 11a executes a program (a command) stored in the memory 11b or the memory section 12, and thereby the controller 11 realizes various kinds of processing. The memory section 12 is a nonvolatile memory to store various data. For example, the memory section 12 has a data base (DB) 12a which stores sorting processing data collected from each of the sorting apparatuses 1. The interface 13 is a network interface to communicate with each of the sorting apparatuses.

The center server 2 performs transmission/reception of data with each of the sorting apparatuses 1 via the interface 13. The center server 2 which can communicate with each of the sorting apparatuses 1 has a function to supply data stored in the memory section 12 in accordance with a request from each of the sorting apparatuses 1. For example, the sorting apparatus 1 demands the number of processing for each sorting information regarding specific sorting information (sorting processing data such as the number of past processing results) of the center server 2. The center server 2 extracts the data from the memory section 12 in accordance with the request from the sorting apparatus 1, and transmits the extracted data to the sorting apparatus 1 of the request source. In other words, in the network system, each of the sorting apparatuses 1 can acquire the past sorting processing data (history information of the sorting processing) which has been collected from the whole system including the other sorting apparatus, from the center server 2.

Next, an example of a configuration of each of the sorting apparatuses 1 will be described. Since each of the sorting apparatuses 1A, 1B, . . . has the same configuration, the sorting apparatus 1A will be described, in the following description. In the configuration example shown in FIG. 1, the sorting apparatus 1A is provided with a sorting apparatus main body B and a computer (a data processor) C. The sorting apparatus main body B is a unit to perform sorting processing. The sorting apparatus main body B has a controller 20, a feeding section 21, a conveying section 22, a discrimination section 23, a stacking section 24, and an operation panel 25.

The controller 20 manages control of the whole sorting apparatus 1. The controller 20 has a processor 31, a memory 32, an interface 33, and a sorting table 34. The processor 31 executes a program (a command) stored in the memory 32, and thereby the controller 20 realizes various kinds of processing. The controller 20 performs control of the respective sections in the sorting apparatus 1, and various data processing. For example, the controller 20 executes setting processing of a processing mode relating to the sorting processing, and so on. In addition, the controller 20 controls conveying of a paper sheet based on a detection signal from a sensor installed in the sorting apparatus 1. In addition, the controller 20 performs a processing to communicate with the center server 2 via the network and so on.

In the example of the configuration shown in FIG. 1, the controller 20 has the sorting table 34 to store sorting designation information as setting information of sorting assignment corresponding to the sorting information. The sorting table 34 has to be referable by the controller 20, and may be a sorting table held by a computer connected to the controller 20 via a network, for example. As for the sorting table 34, the setting information is registered and updated by the controller 20, or the setting information is registered and updated by the computer C. The setting information to be stored in the sorting table 34 is created or updated by an optimization processing of the sorting designation described later.

The feeding section 21 has a tray 41 and a takeout mechanism 42. The tray 41 holds a paper sheet that is an object of the sorting processing. Paper sheets are housed with the rear ends aligned in an upright position in the tray 41, so that first surfaces of the paper sheets that are surfaces on each of which address information is described as the sorting information, are directed to the same direction. The tray 41 feeds the housed paper sheet to a prescribed takeout position. The takeout mechanism 42 takes out the paper sheets one by one at the takeout position on the tray at a prescribed interval. The takeout mechanism 42 feeds the taken out paper sheet to the conveying section 22.

The conveying section 22 has conveying paths 43, 44. The conveying path 43 conveys the paper sheets which have been taken out by the feeding section 21 at a prescribed takeout interval to the discrimination section 23 at a constant conveying interval (pitch). The conveying path 43 is composed of a conveying belt which runs at a constant speed. On the conveying path 43, a foreign body/hardness detecting section which detects whether or not a paper sheet is mechanically processable, and an exclusion stacking section to exclude a paper sheet which has been judged not to be mechanically processable may be provided. The conveying path 44 conveys the paper sheet which has passed the discrimination section 23 to the stacking section 24.

The discrimination section 23 discriminates the sorting information of a paper sheet. The discrimination section 23 has a scanner 45 and a recognition section 46. The scanner 45 optically reads an image on a first surface of the paper sheet provided with the sorting information. The recognition section 46 recognizes the sorting information from the image read by the scanner 45. For example, when the sorting information is written in characters, the recognition section 46 recognizes the sorting information by character recognition processing for the read image of the paper sheet. In the character recognition processing, the recognition section 46 may specify the sorting information as the recognition result, with reference to the sorting information registered in an address information data base or the sorting table 34. In addition, when a bar code indicating the sorting information is printed on a paper sheet, the recognition section 46 extracts the bar code from the image of the paper sheet which the scanner 45 has read, and converts the bar code into the sorting information.

The discrimination result of the sorting information by the discrimination section 23 is notified to the controller 20. The controller 20 determines a sorting destination of the paper sheet, based on the discrimination result of the sorting information by the discrimination section 23, and the sorting designation information of the sorting table 34. The controller 20 controls the conveying of the paper sheet, in accordance with the determined sorting destination. The paper sheet which has passed through the read position by the scanner 45 is conveyed to the stacking section 24 by the conveying path 44 of the conveying section 22. In addition, a paper sheet whose sorting information has not been discriminated by the time the paper sheet is conveyed to the stacking section 24 is rejected.

The stacking section 24 has a plurality of gates G (G1, G2, . . . ) and a plurality of stackers S (S1, S2, . . . , SN). The stacking section 24 drives each of the gates G (G1, G2, . . . ) based on an instruction of a stacker of the sorting destination from the controller 20 or a direct drive instruction of each gate, and thereby selectively stacks paper sheets in the respective stackers S1, . . . , SN. The total number N of the stackers in the stacking section 24 is set for each sorting apparatus. For example, the total number N of the stackers is set in accordance with the operation form, the processing amount, or the like of the sorting apparatus. For example, in the stacking section 24, N stackers S1, . . . , SN are arranged in a form of n rows by m columns.

The sorting information discriminated by the discrimination section 23 is notified to the controller 20. The controller 20 determines a stacker for stacking the relevant paper sheet, that is a sorting destination, based on the sorting information as the discrimination result by the discrimination section 23, and the sorting designation information stored in the sorting table 34. When having determined the stacker to stack the paper sheet, the controller 20 controls each of the gates G so as to convey the paper sheet to the determined stacker.

In addition, the sorting apparatus main body B has the operation panel 25. The operation panel 25 is connected to the controller 20. The operation panel 25 has an operation section and a display section. For example, the operation panel 25 may be composed of a display device incorporated with a touch panel, and so on. The display section displays various kinds of information such as an operation guide or a processing status. An operator inputs various kinds of information, using the operation section.

In addition, the computer C is connected to the sorting apparatus main body B. In the configuration example shown in FIG. 1, the computer C is connected to the interface 33 of the controller 20 in the sorting apparatus main body B, and the interface 13 of the center server 2. In the configuration example shown in FIG. 1, the computer C has a processor 51, a memory 52, an interface 53, and so on.

The processor 51 executes a program (a command) stored in the memory 52, to realize various kinds of processing. The memory 52 has a nonvolatile memory to store the program which the processor 51 executes, a volatile memory to temporarily store data for working, and a nonvolatile memory with a large capacity to store data, and so on. The interface 53 has a communication interface to communicate with the controller 20 of the sorting apparatus main body B, and a network interface to communicate with the center server 2 via a network. That is, the computer C has a communication section to communicate d with the external devices.

The processor 51 executes the program stored in the memory 52, and thereby the computer C executes an optimization processing of the sorting designation which optimizes the setting information of the sorting processing, based on the information acquired from the center server 2. That is, when the processor 51 executing the program stored in the memory 52, the computer C constitutes an acquisition section which acquires the result data for the respective sorting information from the external device via the communication section, constitutes a first generation section which generates sorting result in which the paper sheets have been sorted in the plurality of stackers in a prescribed order, by a two-pass sorting processing of result data indicating the numbers of past processing for respective sorting information, and constitutes a second generation section which generates setting information of a sorting processing of a first pass in which the sorting information and the stackers are correlated, using the sorting result generated by the first generation section. The computer C executes the optimization processing of the sorting designation, and thereby registers the setting information indicating a stacker of the sorting destination for each of sorting information into the sorting table 34, or updates the setting information.

Next, a two-pass sorting processing in the sorting apparatus 1 will be schematically described. The present sorting apparatus 1 performs sorting processing to align paper sheets in a prescribe order in the sorting apparatus main body B, based on the sorting information. The sorting apparatus main body B performs a sorting processing using a radix sorting method, so as to sort paper sheets in a prescribed order, based on the sorting information. The radix sorting method is a method to sort so as to align paper sheets in a prescribed order (delivery order, for example) based on the sorting information, by performing a plural number of times of sorting processing. According to the sorting apparatus main body B according to the present embodiment, paper sheets are aligned in a prescribed order by a first (a first pass) sorting processing, and paper sheets are resupplied in a prescribed order, and the whole paper sheets are aligned in a prescribed order by a second (a second pass) sorting processing. That is, the sorting apparatus main body B executes the sorting processing by the sorting processing of two passes (two-pass processing).

In the two-pass processing, paper sheets are sorted based on the sorting designation information (sorting setting information) stored in the sorting table 34. The sorting designation information to be stored in the sorting table 34 includes setting information (a first pass face) to indicate a sorting destination (a stacker) corresponding to each sorting information in the sorting processing of a first pass, and setting information (a second pass face) to indicate a sorting destination (a stacker) corresponding to each sorting information in the sorting processing of a second pass. For example, when the sorting information is a number of two digits, there is a following method, as an algorithm to align paper sheets in a prescribed order by two-pass processing. Paper sheets which are randomly aligned are sorted by the number of a first digit in the sorting processing of the first pass. The paper sheets which are to be fed in the order which have been sorted in the sorting processing of the first pass are sorted by the number of a second digit in the sorting processing of the second pass. According to this method, the whole paper sheets can be aligned in a desired order.

In the actual sorting processing, paper sheets of the designated sorting information are stacked in the respective stackers with a determined physical capacity (the number of maximum stacking). For this reason, if paper sheets of specific sorting information are more than assumed, there is a possibility that the specific stacker overflows. In addition, since the sorting information is in an undetermined state, in the sorting processing of the first pass, it is not possible to assign the stackers in accordance with the actual sorting information. The sorting apparatus 1 of the present embodiment performs an optimization processing of the sorting designation which uniformalizes (averages) the numbers of stacking of the respective stackers, using the past processing data (result data) acquired from the center server 2, even in the sorting processing of the first pass.

Next, a flow of an optimization processing of the sorting designation which the sorting apparatus 1 performs will be described. The sorting apparatus 1 has a function to perform an optimization processing of the sorting designation which optimizes the sorting designation information registered in the sorting table 34, based on the past processing data. The sorting apparatus 1 can execute the optimization processing of the sorting designation at an optional timing. For example, the optimization processing of the sorting designation may be executed in accordance with an operator's instruction, may be executed regularly, and may be executed when a specific event occurs. Here, it is assumed that the sorting apparatus 1 executes the optimization processing of the sorting designation in accordance with an operator's instruction.

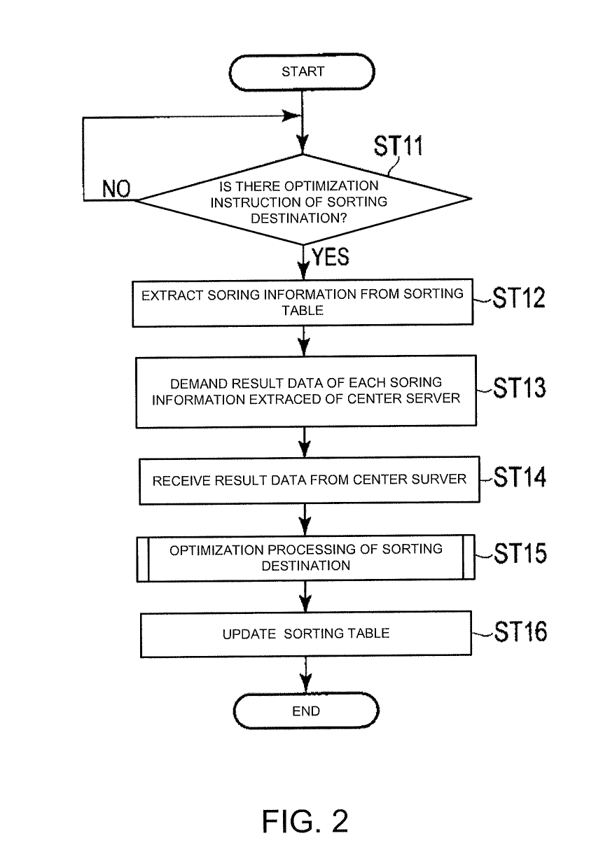

FIG. 2 is a flow chart for explaining an operation example of an optimization processing of the sorting designation. When the optimization processing of the sorting designation is executed, an operator instructs the execution of the optimization processing of the sorting designation, on the operation panel 25 of the sorting apparatus main body B. In the sorting apparatus main body B, the controller 20 detects the instruction content inputted to the operation panel 25. When having detected the execution instruction of the optimization processing of the sorting designation, the controller 20 requests an optimization processing of the sorting designation to the computer C. The computer C accepts the request of the optimization processing of the sorting designation from the controller 20 of the sorting apparatus main body B, and executes the optimization processing of the sorting designation. In addition, the controller 20 may execute the optimization processing of the sorting designation. In this case, the processing of the computer C described later has only to be executed as the processing of the controller 20.

When having received the execution request of the optimization processing of the sorting designation (ST11, YES), the processor 51 of the computer C extracts the sorting information from the sorting table 34 (ST12) as the sorting information which the relevant sorting apparatus 1 uses. That is, the processor 51 extracts the sorting information (address information, for example) which is used for the sorting processing (sorting designation) in the relevant sorting apparatus 1.

When having extracted the sorting information, the processor 51 requests data (hereinafter, referred to as result data) relating to the numbers of past processing (full number) for the respective extracted sorting information, to the center server 2 (ST13). Here, the result data is not limited to the numbers of past processing in only the relevant sorting apparatus 1, but may be data obtained by totaling up the numbers of past processing in the all sorting apparatuses in the whole relevant network system.

In addition, the result data is not the numbers of past processing in the all sorting apparatuses, but may be the numbers of past processing in the relevant sorting apparatus, and may be the total of the numbers of past processing in a plurality of specific sorting apparatuses which have been designated previously. In addition, the result data may be the numbers of past processing in a specific term. For example, as the specific term, a term can be assumed, such as, last several months, last several years, a specific month in the past several years (for December, for example), a specific season of the past several years (spring, summer, autumn or winter), or a specific term (Year-end and New Year holidays, for example).

The center server 2 has a function to transmit the requested result data, in accordance with the request of the result data from the sorting apparatus 1, to the sorting apparatus 1 of the request source. That is, when the request of the result data is accepted, in the controller 11 of the center server 2, the processor 11a extracts the numbers of past processing for the respective requested sorting information, from the processing history information stored in the database 12a of the memory section 12. The processor 11a totals up the numbers of processing of the extracted respective sorting information, to create the result data requested from the sorting apparatus. When the result data is completed, the processor 11a transmits the created result data to the sorting apparatus 1 of the request source of the result data by the interface 13.

The computer C of the sorting apparatus 1 receives the result data from the center server 2 by the interface 53 (ST14). Having acquired the result data indicating the numbers of past processing for the respective sorting information, the processor 51 of the computer C performs an optimization processing of the sorting destination based on the relevant result data (ST15). The optimization processing of the sorting designation is a processing to optimize the sorting designation of the sorting processing of the first pass in the two-pass sorting processing (two-pass processing), based on the past data. The detail of the optimization processing of the sorting designation will be described later.

The processor 51 creates the setting information of the sorting designation indicating assignment of a stacker for the sorting information, by the optimization processing of the sorting designation. In addition, the processor 51 creates the setting information (the first pass face) of the sorting designation of the first pass, and the setting information (the second pass face) of the sorting designation of the second pass. Having created the setting information (the first pass face and the second pass face) of the sorting designation in which the sorting designation has been optimized, the processor 51 updates the sorting table 34 of the sorting apparatus main body B, based on the setting information of the sorting designation which has been created by the optimization processing of the sorting designation (ST16).

In the manner described above, in accordance with an operator's instruction or the like, each of the sorting apparatuses 1 executes the optimization processing of the sorting designation so as to optimize the sorting table using the past data which the center server 2 collects. By this means, even if the sorting information of the object to be processed is in the undetermined state, the sorting apparatus can assign each of the stackers in the stacking section to the sorting information, based on the past processing data (result). As a result of this, a probability that the stacker becomes full and thereby the sorting processing is stopped is decreased, and the availability is improved. In addition, the times of sweeping by an operator, associated with a full state of the stacker is decreased, and a working amount of an operator can be reduced.

Next, the two-pass processing and the optimization processing of the sorting designation will be described. Each of the sorting apparatuses 1 can acquire the full number data indicating the number of past processing for the specific sorting information from the center server 2. In the case of executing the optimization processing of the sorting designation, the computer C of each of the sorting apparatuses 1 acquires the result data indicating the number of past processing for each sorting information, simulates the result of the two-pass processing using the acquired result data, and sets the sorting destination of the first pass based on the simulation result. That is, the computer C can acquire the result of the two-pass processing from the result data acquired form the center server 2, and executes the optimization processing of the sorting designation using the result of the two-pass processing for the result data.

In this manner, if the processing to optimize the first pass face is performed from the result of the two-pass processing (simulation result) based on the result data acquired from the center server 2, the numbers of stacking of the respective stackers are uniformalized in the sorting processing of the first pass, interruption of the sorting processing caused by the overflow of the stacker can be reduced, and the work of the operator can be reduced. In addition, when the difference between the result data and the sorting information of the paper sheet to be actually processed becomes large, it is estimated that the difference in the numbers of stacking of the respective stackers also becomes large. But, in the center server 2, since the sorting processing result for the paper sheets which have become the object to be processed continues to increase, it is thought that each of the sorting apparatuses 1 can perform the optimization processing of the stacker suitable for the current condition, by appropriately executing the optimization processing of the sorting designation.

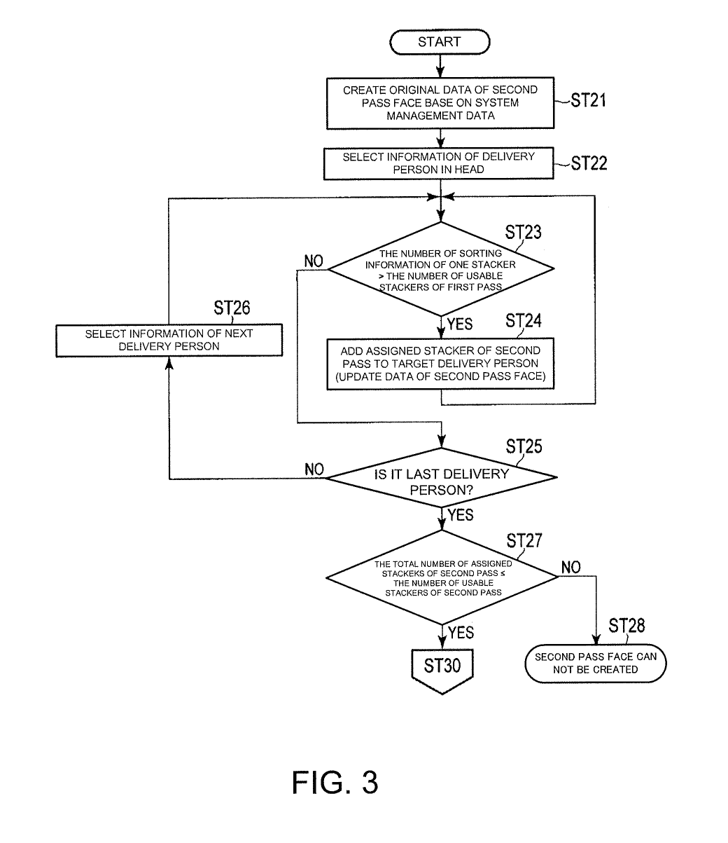

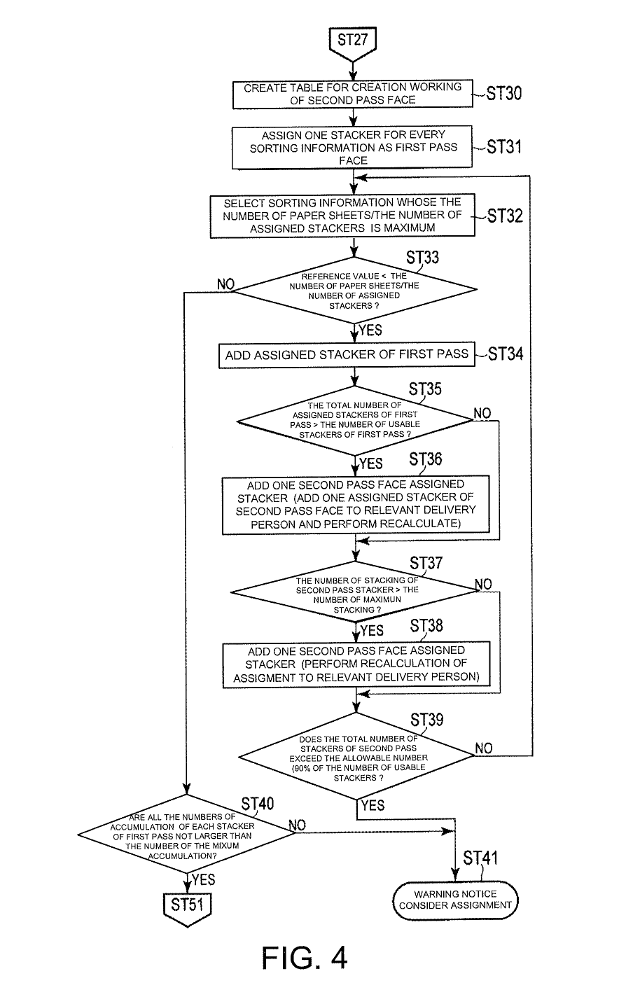

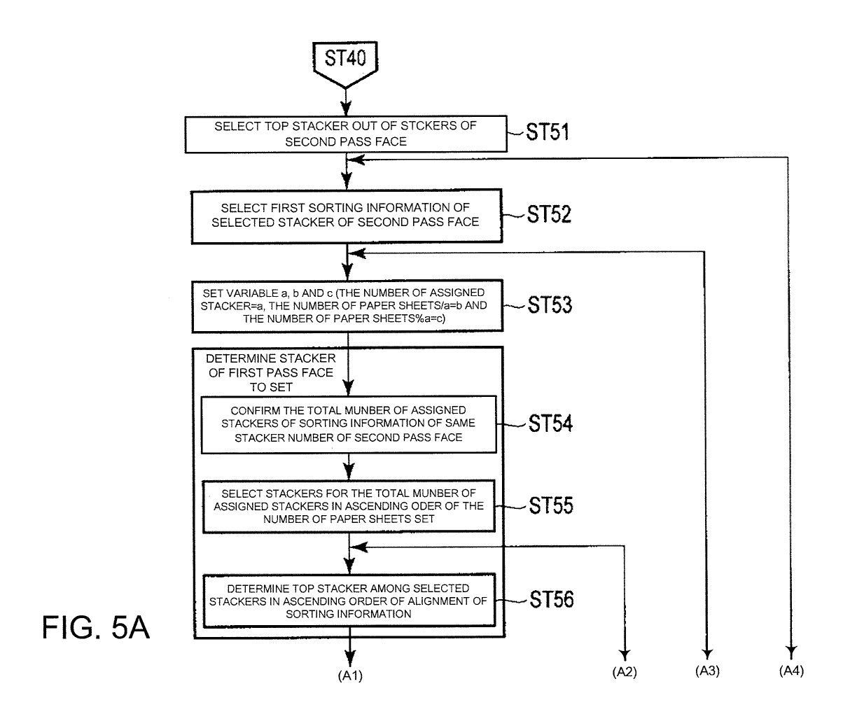

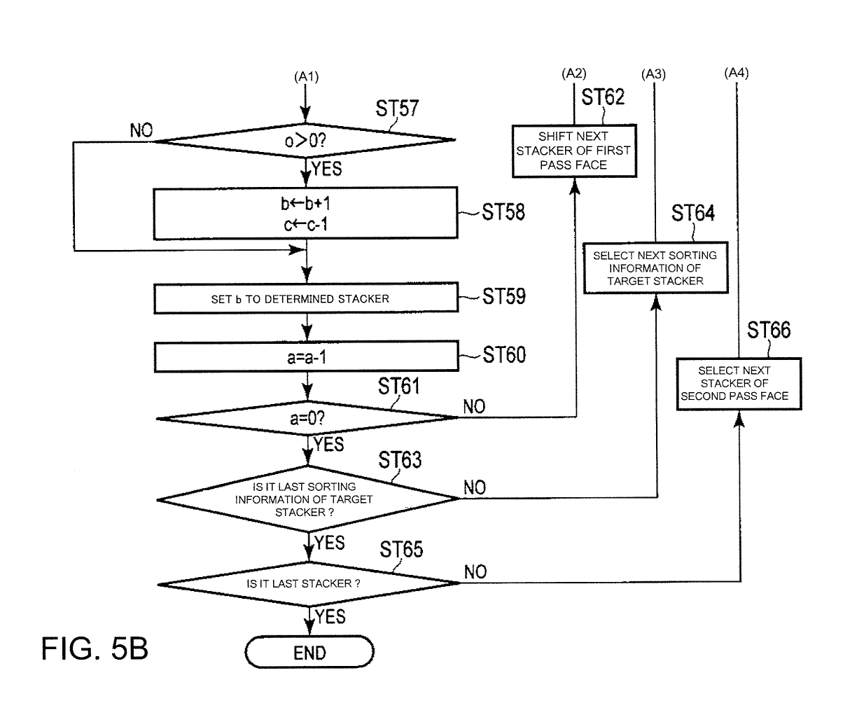

Next, a generation processing of the first pass face and the second pass face as the optimization processing of the sorting designation will be described. FIG. 3, FIG. 4, FIG. 5A, and FIG. 5B are each a flow chart for explaining an example of a generation processing of the first pass face and the second pass face. In the following description, it is assumed that the computer C of the sorting apparatus 1 executes the generation processing of the first pass face and the second pass face. That is, in the sorting apparatus 1, the processor 51 of the computer C creates the second pass face in accordance with the result data, and creates the first pass face based on the created second pass face.

However, the controller 20 of the sorting apparatus main body B may execute the generation processing of the first pass face and the second pass face, and the center server 2 may execute the generation processing of the first pass face and the second pass face in response to a request from the sorting apparatus 1. In addition, here, a case is assumed in which the sorting apparatus performs the sorting processing to align paper sheets in a prescribed order for each delivery person (delivery unit) in charge. In an operation like this, as the result of the sorting processing (two-pass processing), it is required that paper sheets are aligned in a prescribed order in the stacker assigned to each delivery person.

To begin with, the processor 51 creates original data of the second pass face (ST21). The processor 51 creates the original data of the second pass face, based on information of delivery persons and information indicating sorting information which the respective delivery persons take charge of. The processor 51 may read information of delivery persons and information indicating sorting information which the respective delivery persons take charge of, from the memory 52 of the computer C. In addition, the processor 51 may acquire information of delivery persons and information indicating sorting information which the respective delivery persons take charge of, from the controller 20 of the sorting apparatus main body B or the center server 2, via the I/F 53.

FIG. 7 is a diagram showing an example of original data of the second pass face. In the example shown in FIG. 7, as the original data of the second pass face, one stackers S1, S2, S3, S4, S5 are respectively assigned to five delivery persons A, B, C, D, E. In addition, the numbers of sorting information which the respective delivery persons take charge of is described. Having created the original data of the second pass face, the processor 51 updates the original data of the second pass face in accordance with the device information such as setting information of the stackers in the sorting apparatus main body B, and management data such as result data for the sorting information, and thereby creates the second pass face.

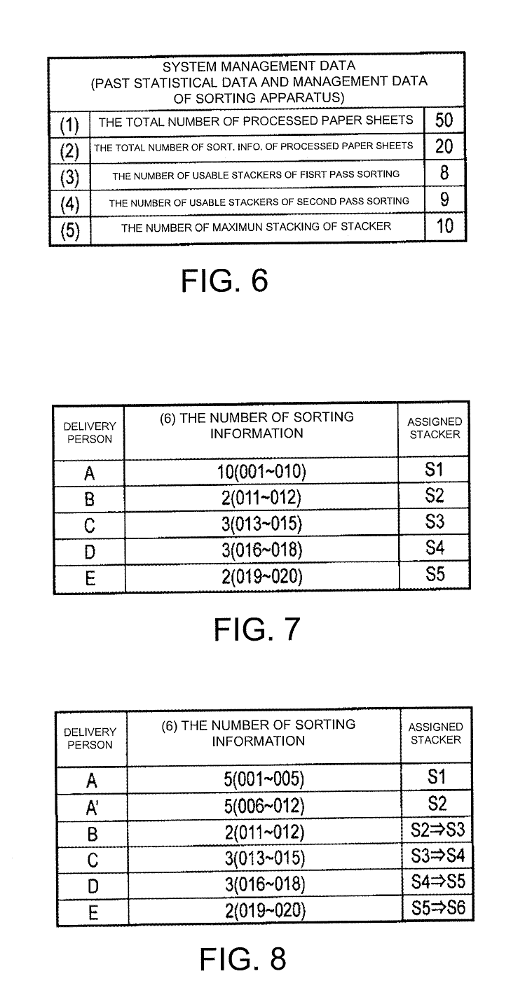

FIG. 6 is a diagram showing an example of the management data. In FIG. 6, examples of “the total number of processed paper sheets”, “the number of sorting information of processed paper sheets”, “the number of stackers which can be used in the sorting processing of the first pass (a first pass sorting) (the number of usable stackers of the first pass)”, “the number of stackers which can be used in the sorting processing of a second pass (a second pass sorting) (the number of usable stackers of the second pass)”, “a maximum stacking number of a stacker” are shown. “The number of maximum stacking of a stacker” is the maximum number of the paper sheets which can be stacked in one stacker.

“The total number of processed paper sheets” and “the total number of sorting information of processed paper sheets” are statistical data indicating the past processing result for the sorting information which the relevant sorting apparatus makes the object of the sorting processing. These statistical data is included in the result data acquired from the center server 2. In addition, in the example shown in FIG. 6, “the total number of processed paper sheets” is “50” and “the total number of sorting information of processed paper sheets” is “20”.

In addition, “the number of usable stackers of the first pass”, “the number of usable stackers of the second pass” and “the number of maximum stacking of a stacker” are device setting information (setting information of the sorting apparatus) in the sorting apparatus main body B. The device setting information may be stored in the memory 52 as the management data, or the processor 51 may acquire the device setting information from the memory 32 of the controller 20 of the sorting apparatus main body B. In addition, in the example shown in FIG. 6, “the number of usable stackers of the first pass” is “8”, “the number of usable stackers of the second pass” is “9”, “the number of maximum stacking of a stacker” is “10”.

That is, having created the original data of the second pass face, the processor 51 selects the information of the top delivery person (ST22). For example, the processor 51 selects the information of the top delivery person A, based on the original data of the second pass face shown in FIG. 7.

The processor 51 judges whether or not the number of sorting information assigned to one stacker is larger than the number of usable stackers of the first pass, in the information corresponding to the selected delivery person (ST23). For example, in the example shown in FIG. 7, the stacker S1 is assigned to the delivery person A, and the sorting information of 10 kinds which the delivery person A takes charge of is assigned to the stacker S1. As shown in FIG. 6, when the number of usable stackers of the first pass is “8”, regarding the information of the delivery person A, it is judged that the number of sorting information assigned to one stacker is larger than the number of usable stackers of the first pass.

When it is judged that the number of sorting information assigned to one stacker exceeds the number of usable stackers of the first pass (ST23, YES), the processor 51 adds the stacker to be assigned of the second pass corresponding to the selected delivery person, and recalculates (updates) the data of the second pass face (ST24). That is, having added the assignment of the stacker to the relevant delivery person, the processor 51 recalculates the data of the second pass face, wherein the sorting information which the relevant delivery person takes charge of has been assigned to the plurality of stackers assigned to the relevant delivery person.

For example, regarding the information of the delivery person A shown in FIG. 7, when it is judged that the number of sorting information assigned to one stacker is larger than the number of usable stackers of the first pass, the processor 51 adds the stacker to the delivery person A, and assigns two stackers to the delivery person A. In this case, the processor 51 divides the sorting information of 10 kinds which the delivery person A takes charge of into two, and assigns two sorting information of 5 kinds to the two stackers, respectively.

FIG. 8 is an example in which the two stackers S1, S2 are assigned to the delivery person A shown in FIG. 7 (the example that the stacker is added). In the example shown in FIG. 8, the sorting information of 5 kinds is assigned to the stacker S1, out of the sorting information of 10 kinds which the delivery person A takes charge of, and the sorting information of remaining 5 kinds which has not been assigned to the stacker S1 is assigned to the stacker S2, out of the sorting information of 10 kinds which the delivery person A takes charge of. In addition, in the example shown in FIG. 8, though the delivery person A is virtually divided into “A” and “A′” as the setting information, the actual delivery person is “A”. For example, when not less than three stackers are assigned to the delivery person A, the processor 51 has only to divide “A” and “A′” into three.

Having added the stacker and updated the data of the second pass face, the processor 51 judges again whether or not the number of sorting information assigned to one stacker exceeds the number of usable stackers of the first pass, regarding the updated data (ST23).

When having judged that the number of sorting information assigned to one stacker does not exceed the number of usable stackers of the first pass (ST23, NO), the processor 51 judges whether or not the selected delivery person is the last delivery person (whether or not the information of the whole delivery persons has been selected) (ST25).

When having judged that the selected delivery person is not the last delivery person (ST25, NO), the processor 51 selects the information of the next delivery person (ST26), and executes the processing from ST23 regarding the selected information of the delivery person.

In addition, when having judged that the selected delivery person is the last delivery person (ST25, YES), the processor 51 judges whether or not the total number of the assigned stackers of the second pass face is not more than the number of usable stackers of the second pass (ST27). When the total number of the stackers of the second pass face exceeds the number of usable stackers of the second pass (ST27, NO), the processor 51 warns that the generation of the second pass face is impossible, and stops the processing (ST28). When the total number of the assigned stackers of the second pass face is not more than the number of usable stackers of the second pass (ST27, YES), the processor 51 performs processing to create the second pass face by combining the data of the created second pass face with the result data (ST30-ST41).

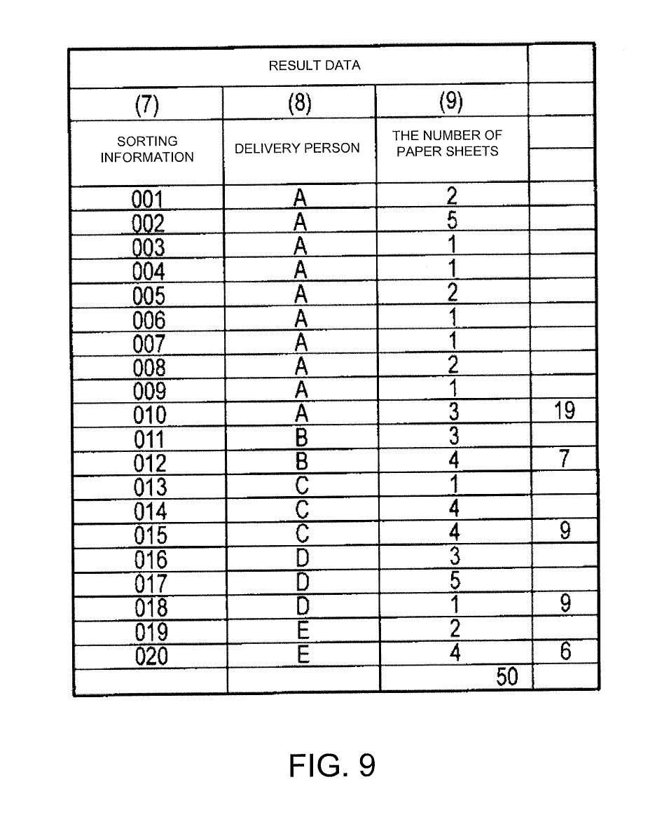

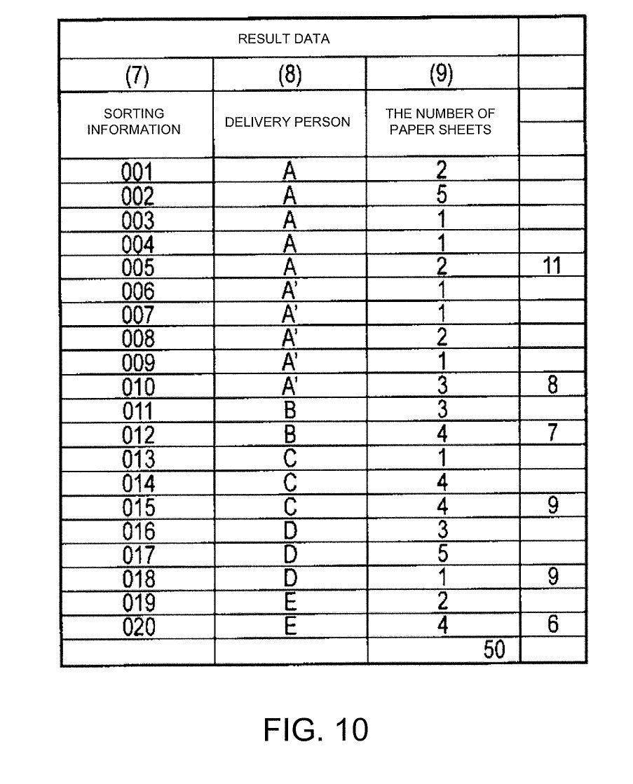

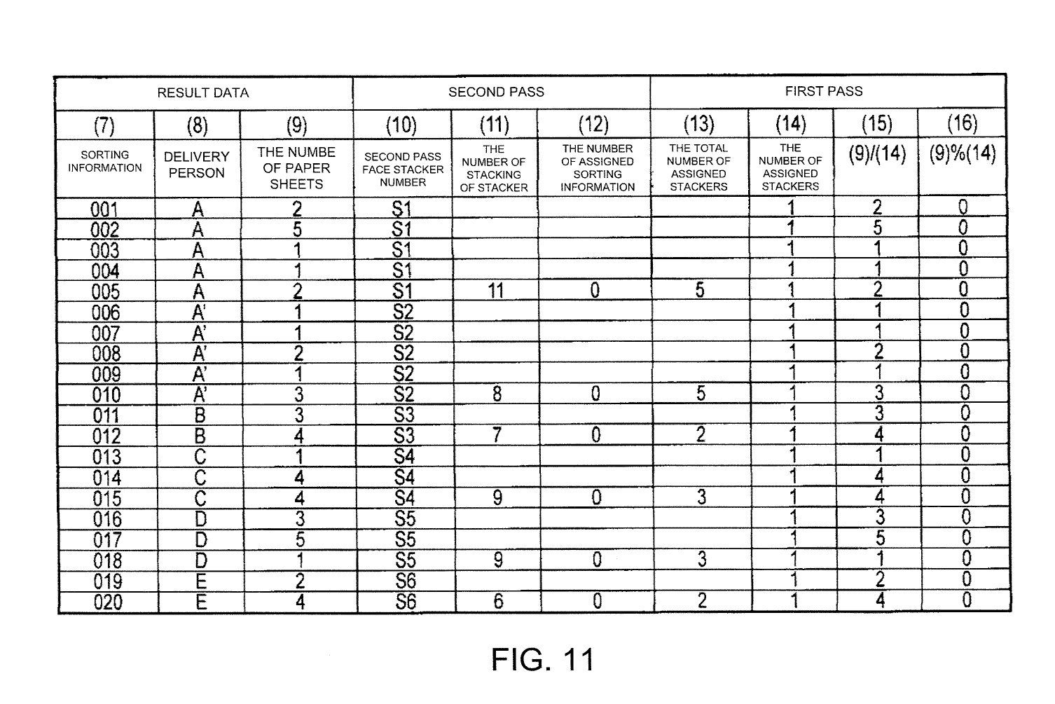

FIG. 9 is an example of the result data for the respective sorting information shown in FIG. 7. “The number of paper sheets” is the number of paper sheets which have been processed in the past for each sorting information. In FIG. 9, the number of paper sheets assigned to each delivery person is additionally written. FIG. 10 shows an example in which the delivery person A is virtually divided into “A” and “A”. In addition, the number of paper sheets assigned to each delivery person is additionally written. FIG. 11 is an example of a table in which the information relating to the second pass face and the information relating to the first pass face are correlated with the result data of FIG. 10. FIG. 11 is a table for generation work of the second pass face based on the result data.

In FIG. 11, “sorting information”, “delivery person”, “the number of paper sheets” are result data. In FIG. 11, “second pass face stacker number”, “the number of stacking of stacker”, and “the number of assigned sorting information” are information relating to the second pass face. “The number stacking of stacker” is the number of paper sheets to be stacked in each stacker, and “the number of assigned sorting information” is the number of sorting information assigned to each stacker. In addition, in FIG. 11, “the total number of assigned stackers”, “assigned stacker number”, “(9)/(14)”, and “(9)%(14)” are information relating to the first pass face. “The total number of assigned stackers” is the total number of stackers assigned in the first pass for one stacker in the second pass. “The number of assigned stackers” is the number of stackers assigned in the first pass for each of sorting information. “(9)/(14)” is “the number of paper sheets/the number of assigned stackers”, that is, “a quotient obtained by dividing the number of paper sheets by the number of assigned stackers”. In addition “(9)% (14)” is “the number of paper sheets % the number of assigned stackers”, that is “a remainder obtained by dividing the number of paper sheets by the number of assigned stackers”.

That is, the processor 51 creates a table for generation work of the second pass face by combining the created data of the second pass face with the result data (ST30). Having created the table for generation work by combining the data of the second pass face with the result data, the processor 51 sets all the “the number of assigned stackers” to “1” as an initial value. That is, the processor 51 assigns one stacker for the first pass, for each of the whole sorting information (ST31). FIG. 11 shows the state in which “the number of assigned stackers” is set to “1” as the initial value.

After having set the initial value to the number of assigned stackers, the processor 51 selects the sorting information in which “the number of paper sheets/the number of assigned stackers” is maximum (ST32). For example, in the example shown in FIG. 11, the sorting information in which “the number of paper sheets/the number of assigned stackers” is maximum are “002” and “017”. Assuming that the sorting information is sequentially selected from above in the working table, the processor 51 selects the sorting information “002”.

The processor 51 judges whether or not “the number of paper sheets/the number assigned stackers” of the selected sorting information is larger than a reference value (ST33). When having judged that “the number of paper sheets/the number of assigned stackers” is larger than the reference value (ST33, YES), the processor 51 performs processing to add a stacker for the first pass to the relevant sorting information (ST34).

As the processing of adding a stacker, the processor 51 increases the number of assigned stackers for the relevant sorting information by one. When having increased the number of assigned stackers, the processor 51 recalculates the number of paper sheets/the number of assigned stackers. By this recalculation, the processor 51 updates “the number of paper sheets/the number of assigned stackers” and “the number paper sheet % the number of assigned stackers”. Further, the processor 51 increases the total number of assigned stackers of the first pass face for the stacker of the second pass face of the relevant sorting information.

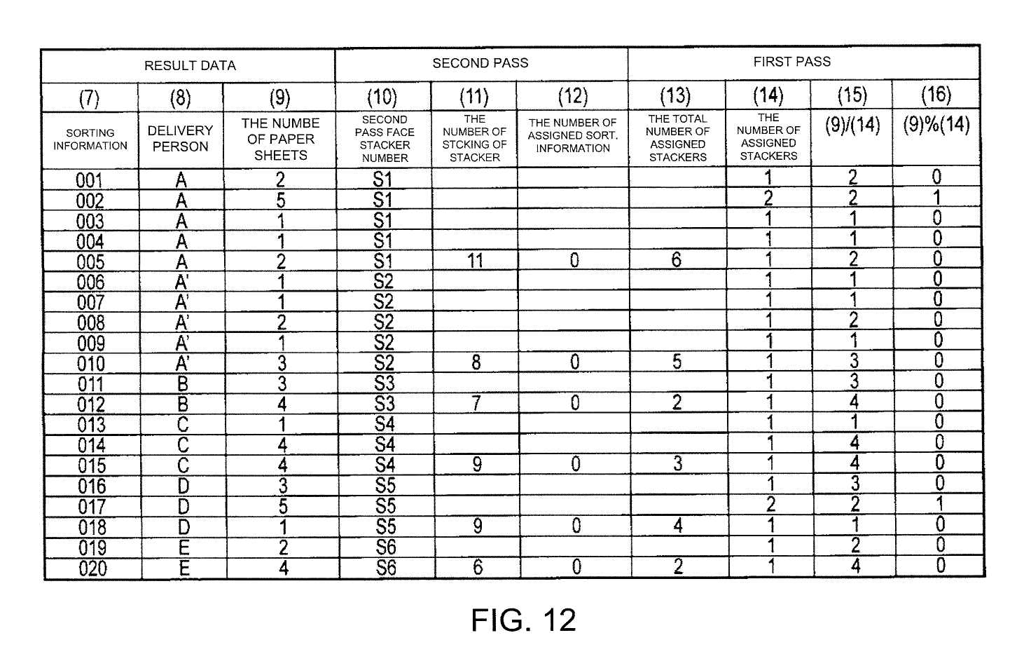

For example, assuming that the reference value for determining the increase of stacker of the first pass is “4”, a stacker of the first pass is added regarding the sorting information “002” in the example shown in FIG. 11. FIG. 12 shows an example in which a stacker of the first pass is added regarding the sorting information “002” and “017” of FIG. 11. That is, when a stacker of the first pass is added regarding the sorting information “002” and “017”, the table shown in FIG. 11 is updated to a table shown in FIG. 12. In the example shown in FIG. 12, regarding the sorting information “002”, “the number of assigned stackers” is updated to “2”, “the number of paper sheets/the number of assigned stackers” is updated to “2”, “the number of paper sheets % the number of assigned stackers” is updated to “1”, and further, “the total number of assigned stackers” of the first pass for the stacker S1 of the second pass face is updated to “6”. In addition, regarding the sorting information “017”, “the number of assigned stackers” is updated to “2”, “the number of paper sheets/the number of assigned stackers” is updated to “2”, “the number of paper sheets % the number of assigned stackers” is updated to “1”, and further, “the total number of assigned stackers” of the first pass for the stacker S1 of the second pass face is updated to “4”.

After having executed the processing of adding a stacker, the processor 51 judges whether or not the total number of stackers of the first pass exceeds the number of usable stackers of the first pass (ST35). When having judged that the number of stackers of the first pass exceeds the number of usable stackers of first pass (ST35, YES), the processor 51 adds one assigned stacker of the second pass face for the relevant delivery person, and performs processing to recalculate the assignment (ST36).

In addition, when it is judged that the number of stackers of the first pass face does not exceed the number of usable stackers of the first pass (ST35, NO), or when the assignment of the second pass face is recalculated, the processor 51 judges whether or not the number of stacking of a stacker of the second pass exceeds the number of maximum stacking of a stacker (ST37).

When having judged that the number of stacking of a stacker of the second pass exceeds the number of maximum stacking of the stacker (ST37, YES), the processor 51 adds one assigned stacker of the second pass face for the relevant delivery person, and performs processing to recalculate the assignment (ST38). For example, in the example shown in FIG. 12, the number of stacking “11” of the stacker S1 exceeds the number of maximum stacking “10” of the stacker shown in FIG. 6. For this reason, one stacker of the second pass for the delivery person A is added, and the assignment of the stacker is recalculated.

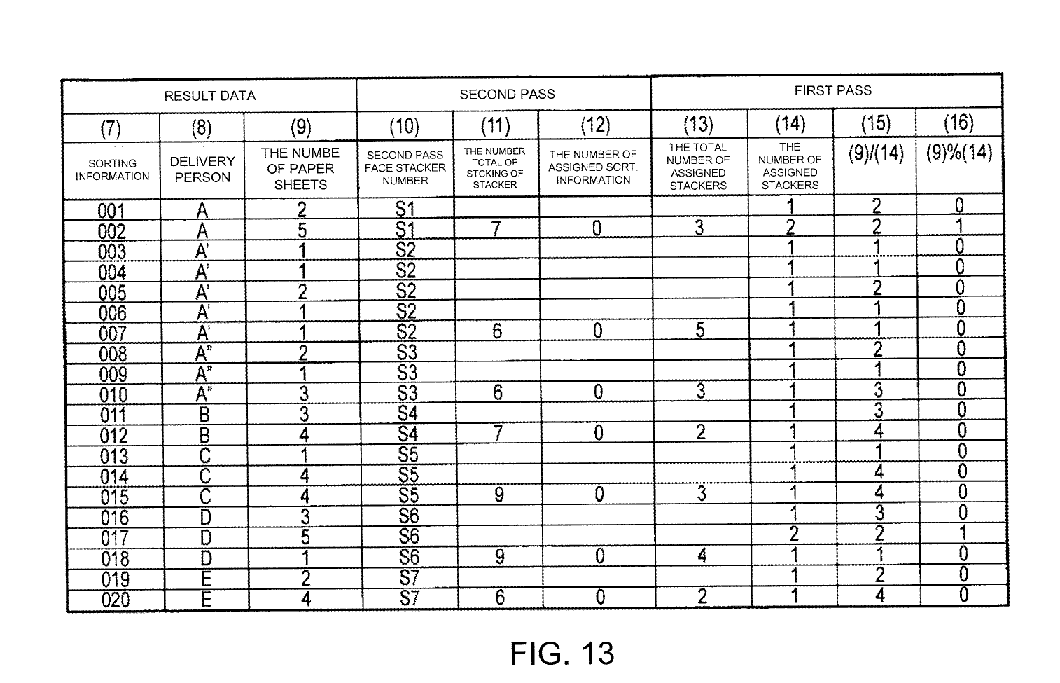

FIG. 13 shows an example in which the assignment of the stacker of the second pass to the delivery person A shown in FIG. 12 has been recalculated. In the example shown in FIG. 13, the three stackers S1, S2, S3 are assigned to the delivery person A as the stackers of the second pass so that the number of stacking of each stacker becomes not more than the number of maximum stacking. In addition, in the example shown in FIG. 13, according to the change of the assignment to the delivery person A, the respective stacker numbers of the stackers of the second pass which are assigned to the delivery persons B, C, D, E are increased by one.

In addition, when it is judged that the total number of assigned stackers does not exceed the number of usable stackers of the first pass (ST37, NO), or when the assignment of the stackers of the second pass face is recalculated, the processor 51 judges whether or not the total number of stackers of the second pass face (a stacker number of the last stacker of the second pass face) exceeds the allowable number (ST39). The allowable number is set so as to provide a margin, so that the stacker does not overflow frequently, even when a number exceeding the result data of paper sheets are supplied. For example, as the allowable number, a prescribed ratio (for example, 90%) to the number of usable stackers of the second pass may be set. Having judged that the total number of stackers of second pass exceeds the allowable number (ST39, YES), the processor 51 informs an alarm, to request the reconsideration of the assignment, and stops the processing (ST41).

When having judged that the total number of stackers of the second pass face does not exceed the allowable number (ST39, NO), the processor 51 returns to ST32, and selects sorting information whose “the number of paper sheets/the number of assigned stackers” is maximum. If “the number of paper sheets/the number of assigned stackers” of this selected sorting information exceeds the reference value (ST33, YES), the processor 51 executes the above-described processing from ST34, by paying attention to the selected information.

When having judged that “the number of paper sheets/the number of assigned stackers” of the selected sorting information does not exceed the reference value (ST33, NO), the processor 51 judges that all the numbers of stacking of the respective stackers of the first pass are not more than the number of maximum stacking (ST40). When having judged that there is one stacker whose number of stacking of the first pass exceeds the number of maximum stacking (ST40, NO), the processor 51 informs an alarm, to request the reconsideration of the assignment, and stops the processing (ST41).

When having judged that the all the numbers of stacking of the respective stackers of the first pass are not more than the number of maximum stacking (ST40, YES), the processor 51 performs processing to generate the first pass face, using the data created by the processing of up to ST40 (ST51-ST66).

Hereinafter, a generation processing of generating the first pass face using the data of the second pass face based on the result data. FIG. 5A and FIG. 5B are a flow chart showing a processing of ST51-ST66 as a processing to generate the first pass face.

The processor 51 selects a top stacker out of the stackers of the second pass face (ST51). When having selected the top stacker of the second pass face, the processor 51 selects first sorting information assigned to the selected stacker of the second pass face (ST52). The processor 51 makes setting of a stacker of the first pass face for the selected sorting information. In addition, the processor 51 defines variables a, b, c corresponding to the selected sorting information (ST53). Here, it is assumed that a is the number of assigned stackers, b is a value (quotient) of the number of paper sheets/the number of assigned stackers, and c is a remainder of the number of paper sheets/the number of assigned stackers. For example, when having selected the sorting information “001” in the example of FIG. 13, the processor 51 sets that a=1, b=2, and c=0.

When having selected the sorting information, the processor 51 determines a stacker of the first pass face in which a paper sheet of the selected sorting information is to be set (ST54-ST56). That is, to begin with, the processor 51 confirms the total number of the assigned stackers of the sorting information of the same stacker number of the second pass face (ST54). Secondly, the processor 51 selects the stackers of the first pass face in the ascending order of the number of paper sheets which have previously been set, by a number of the total number of the assigned stackers of the sorting information of the same stacker number of the second pass (ST55). Thirdly, the processor 51 determines a top stacker in which the paper sheet has not been set out of the selected stackers, in order to assign the selected stackers in the ascending order (alignment order) of the sorting information (ST56).

For example, when having selected the sorting information “001” in the example of FIG. 13, the processor 51 confirms that a total number of the number of assigned stackers “1” of the sorting information “001”, and the number of assigned stackers “2” of the sorting information “002” is “3”, wherein the stacker S1 is assigned to the sorting information “001” and “002”. In this case, since the whole stackers are vacant, the processor 51 selects three stackers S1, S2, S3 for the sorting information “001” and “002”. The processor 51 selects the top stacker S1 out of the three stackers, as a stacker for setting paper sheets of the sorting information “001”.

When having determined the stacker of the first pass face, the processor 51 judges whether or not c>0 (ST57). When having judged that c>0, the processor 51 sets the value of b to (b+1), and sets the value of c to (c−1) (ST58). When c is not larger than 0, that is, when c=0, (ST57, NO), or when the value of b is updated (ST58), the processor 51 sets the value of b to the stacker which has been determined as the stacker of the first pass face (ST59). Having set the value of b to the stacker, the processor 51 sets the value of a to (a−1) (ST60), and then judges whether or not a=0 (ST61).

When having judged that a is not 0 (ST61, NO), the processor 51 makes setting of a next stacker of the first pass face. In this case, the processor 51 proceeds to ST56, and determines the top stacker whose first pass face has not been set, out of the stackers which have been selected in ST55 (ST56), and executes the processing of ST58-ST61.

In addition, when having judged that a=0 (ST61, YES), the processor 51 judges whether the present sorting information is the last sorting information to which the selected stacker of the second pass face has been assigned (ST63). When having judged that the present sorting information is not the last sorting information (ST63, NO), the processor 51 selects the next sorting information out of the sorting information to which the same stacker has been assigned (step ST64), and executes the processing of ST53-ST63 regarding the selected sorting information.

When having judged that the present sorting information is the last sorting information (ST63, YES), the processor 51 judges whether or not the selected stacker of the second pass face is the last stacker (ST65). When having judged that the selected stacker is not the last stacker (ST65, NO), the processor 51 selects a next stacker of the second pass face from the stackers of the second pass face (step S66), and executes the processing of ST52-ST65, regarding the selected stacker of the second pass face. By the above-described processing of ST51-ST65, the first pass face is set for the sorting information of the whole paper sheets obtained by the result data. Next, the setting of the first pass face to be obtained by the above-described processing of ST51-ST65 will be described, using the data shown in FIG. 13 as an example.

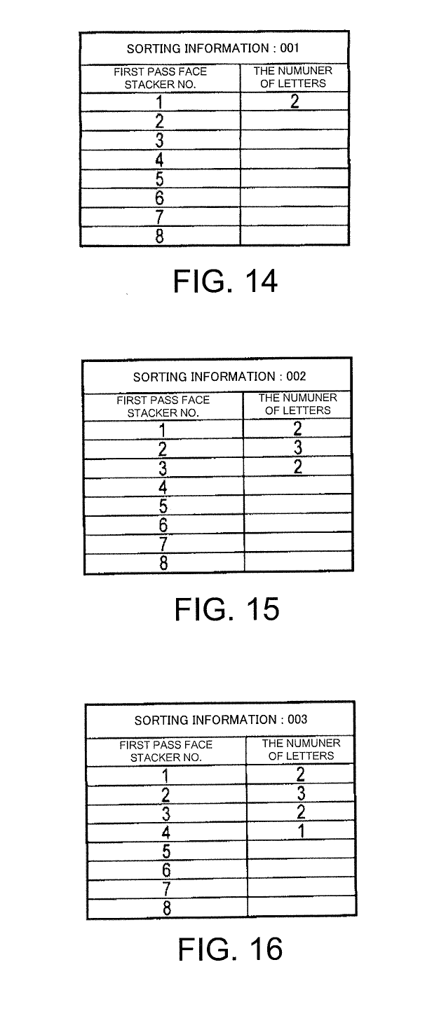

FIG. 14-FIG. 33 are each a setting example of the first pass face which is set by the above-described processing of ST51-ST65. In FIG. 14-FIG. 33, the number of paper sheets is set corresponding to the stacker number. To begin with, the sorting information “001” and “002” is assigned to the stacker S1 of the second pass face. The three stackers S1, S2, S3 are set to the sorting information “001” and “002”, as the stackers of the first pass face, as shown in FIG. 14 and FIG. 15. FIG. 14 is a table showing the setting of the first pass face for the sorting information “001”. As shown in FIG. 14, “2” is set to the stacker S1, regarding the sorting information “001”. FIG. 15 shows a table in which the setting of the first pass face for the sorting information “002” has been added. Regarding the sorting information “002”, the assigned stacker number is “2”. For this reason, regarding the sorting information “002”, as shown in FIG. 15, “3” is set to the stacker S2 following the stacker S1, and “2” is set to the stacker S3 following the stacker S2.

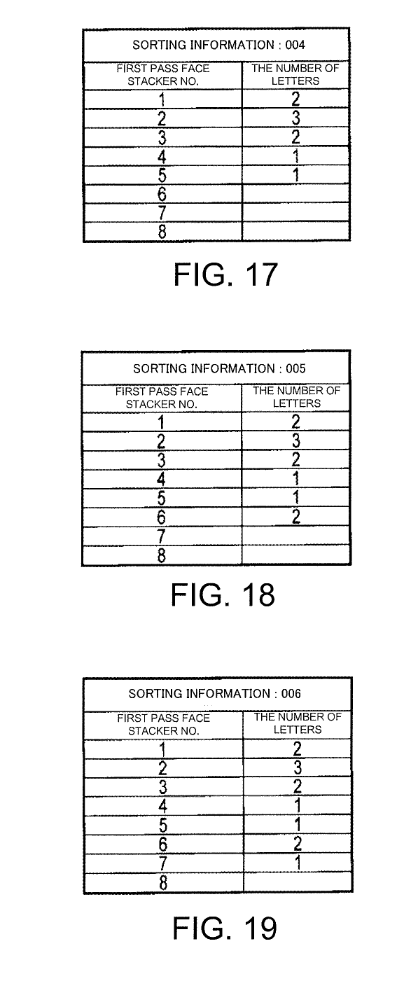

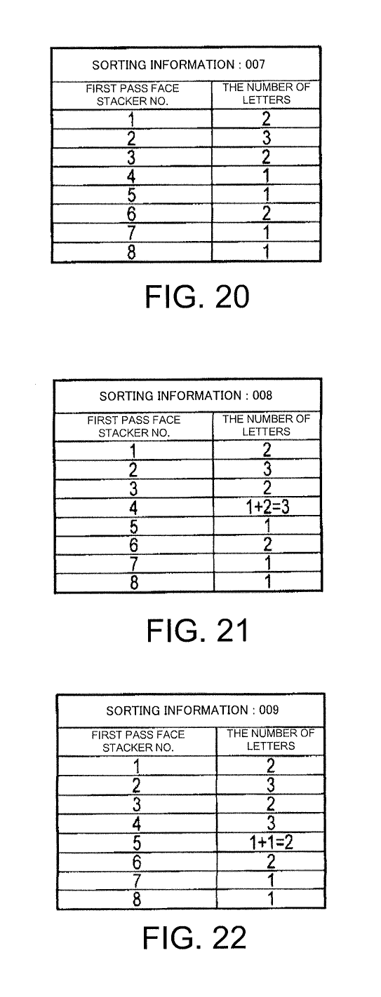

In addition, the sorting information “003”, “004”, “005”, “006” and “007” is assigned to the stacker S2 of the second pass face. The five stackers S4, S5, S6, S7 and S8 are set to the sorting information “003”-“007” as the stackers of the first pass face, as shown in FIG. 16 to FIG. 20. FIG. 16 is a table in which the setting of the first pass face for the sorting information “003” has been added. As shown in FIG. 16, “1” is set to the stacker S4 regarding the sorting information “003”. FIG. 17 shows a table in which the setting of the first pass face for the sorting information “004” has been added. As shown in FIG. 17, “1” is set to the stacker S5 following the stacker S4 regarding the sorting information “004”. FIG. 18 shows a table in which the setting of the first pass face for the sorting information “005” has been added. As shown in FIG. 18, “2” is set to the stacker S6 following the stacker S5 regarding the sorting information “005”. FIG. 19 shows a table in which the setting of the first pass face for the sorting information “006” has been added. As shown in FIG. 19, “1” is set to the stacker S7 following the stacker S6 regarding the sorting information “006”. FIG. 20 shows a table in which the setting of the first pass face for the sorting information “007” has been added. As shown in FIG. 20, “1” is set to the stacker S8 following the stacker S7 regarding the sorting information “007”.

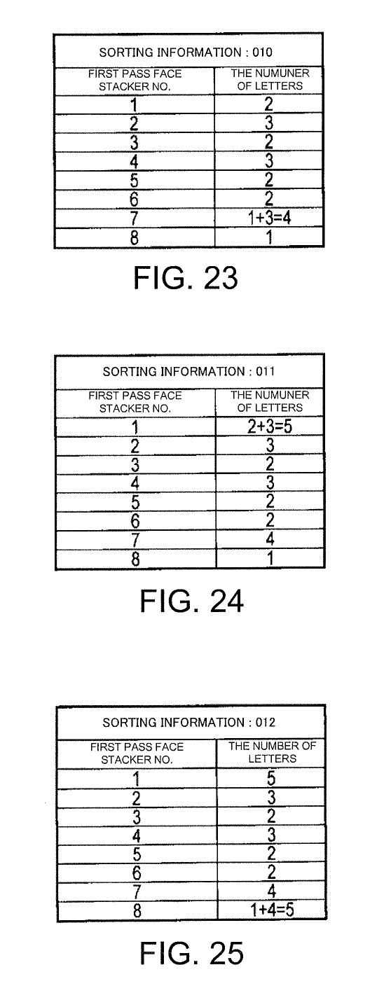

In addition, the sorting information “008”, “009” and “010” is assigned to the stacker S3 of the second pass face. Three stackers are set to the sorting information “008”-“010” as the stackers of the first pass face, as shown in FIG. 21 to FIG. 23. The three stackers S4, S5 and S6 in each of which a small number of paper sheets are set are selected as the three stackers. FIG. 21 shows a table in which the setting of the first pass face for the sorting information “008” has been added. As shown in FIG. 21, regarding the sorting information “008”, “2” is added to the stacker S4, and the stacker S4 is updated to “1+2=3”. FIG. 22 shows a table in which the setting of the first pass face for the sorting information “009” has been added. As shown in FIG. 22, regarding the sorting information “009”, “1” is added to the stacker S5, and the stacker S5 is updated to “1+1=2”. FIG. 23 shows a table in which the setting of the first pass face for the sorting information “010” has been added. As shown in FIG. 23, regarding the sorting information “010”, “3” is added to the stacker S7, and the stacker S7 is updated to “1+3=4”.

In addition, the sorting information “011” and “012” is assigned to the stacker S4 of the second pass face. Two stackers are set to the sorting information “011” and “012” as the stackers of the first pass face, as shown in FIG. 24 to FIG. 25. The two stackers S1 and S8 in each of which a small number of paper sheets are set are selected as the two stackers. FIG. 24 shows a table in which the setting of the first pass face for the sorting information “011” has been added. As shown in FIG. 24, regarding the sorting information “011”, not the stacker S8 in which the smallest number of paper sheets are set, but the stacker S1 of the top side is selected out of the stackers S1 and S8. By this means, regarding the sorting information “011”, “3” is added to the stacker S1, and the stacker S1 is updated to “2+3=5”. FIG. 25 shows a table in which the setting of the first pass face for the sorting information “012” has been added. As shown in FIG. 25, regarding the sorting information “012”, “4” is added to the stacker S8, and the stacker S8 is updated to “1+4=5”.

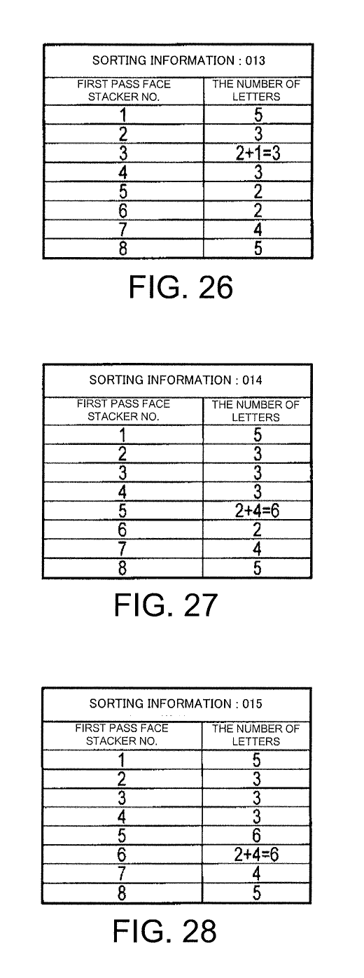

In addition, the sorting information “013”, “014” and “015” is assigned to the stacker S5 of the second pass face. Three stackers are set to the sorting information “013”-“014”, as the stackers of the first pass face, as shown in FIG. 26 to FIG. 28. The three stackers S3, S5 and S6 in each of which a small number of paper sheets are set are selected as the three stackers. FIG. 26 shows a table in which the setting of the first pass face for the sorting information “013” has been added. As shown in FIG. 26, regarding the sorting information “013”, “1” is added to the stacker S3, and the stacker S3 is updated to “2+1=3”. FIG. 27 shows a table in which the setting of the first pass face for the sorting information “014” has been added. As shown in FIG. 27, regarding the sorting information “014”, “4” is added to the stacker S5, and the stacker S5 is updated to “2+4=6”. FIG. 28 shows a table in which the setting of the first pass face for the sorting information “015” has been added. As shown in FIG. 28, regarding the sorting information “015”, “4” is added to the stacker S6, and the stacker S6 is updated to “2+4=6”.

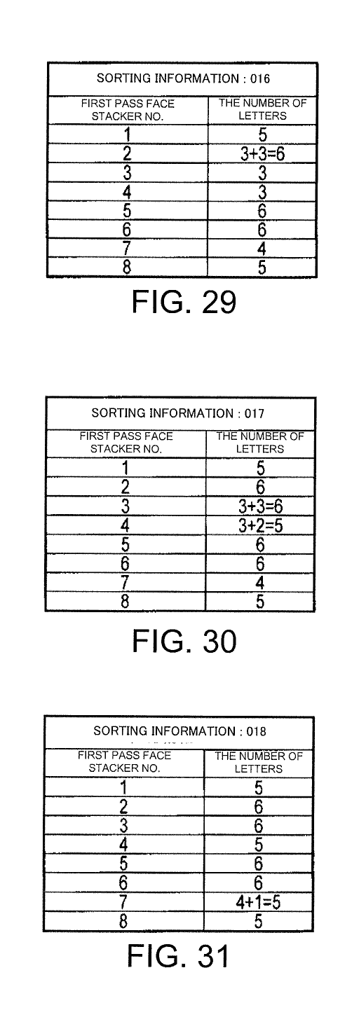

In addition, the sorting information “016”, “017” and “018” is assigned to the stacker S6 of the second pass face. Four stackers are set to the sorting information “016”-“018”, as the stackers of the first pass face, as shown in FIG. 29 to FIG. 31. The four stackers S2, S3, S4 and S7 in each of which a small number of paper sheets are set are selected, as the four stackers. FIG. 29 shows a table in which the setting of the first pass face for the sorting information “016” has been added. As shown in FIG. 29, regarding the sorting information “016”, “3” is added to the stacker S2, and the stacker S2 is updated to “3+3=6”. FIG. 30 shows a table in which the setting of the first pass face for the sorting information “017” has been added. As shown in FIG. 30, since the number of assigned stackers for the sorting information “017” is “2”, the stackers S3 and S4 are assigned to the sorting information “017”. Regarding the sorting information “017”, “b+c=3” is added to the stacker S3, and the stacker S3 is updated to “3+3=6”, and further, “b=2” is added to the stacker S4, and the stacker S4 is updated to “3+2=5”. In addition, FIG. 31 shows a table in which the setting of the first pass face for the sorting information “018” has been added. As shown in FIG. 31, regarding the sorting information “018”, “1” is added to the stacker S7, and the stacker S7 is updated to “4+1=5”.

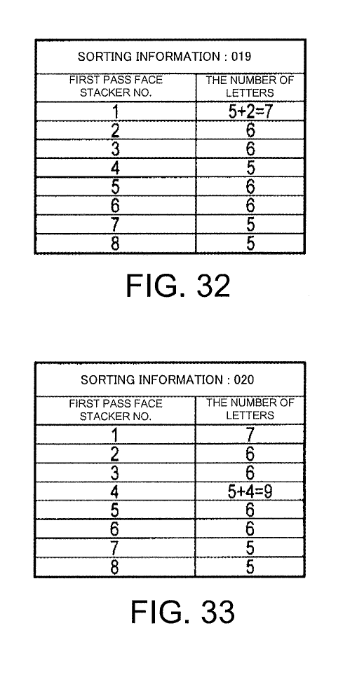

In addition, the sorting information “019” and “020” is assigned to the stacker S7 of the second pass face. Two stackers are set to the sorting information “019” and “020”, as the stackers of the first pass face, as shown in FIG. 32 and FIG. 33. The two stackers S1 and S4 in each of which a small number of paper sheets are set are selected, as the two stackers.

FIG. 32 shows a table in which the setting of the first pass face for the sorting information “019” has been added. As shown in FIG. 32, regarding the sorting information “019”, “2” is added to the stacker S1, and the stacker S1 is updated to “5+2=7”. FIG. 33 shows a table in which the setting of the first pass face for the sorting information “020” has been added. As shown in FIG. 33, r the sorting information “020”, “4” is added to the stacker S4, and the stacker S4 is updated to “5+4=9”.

When the above-described processing is applied, the sorting apparatus of the present embodiment can create the first pass face which can uniformly sort paper sheets into the respective stackers, based on the past processing data (result data). For example, in the example shown in FIG. 33, there is no stacker which becomes full in the final setting result of the first pass face. If paper sheets to be actually fed have the tendency similar to the result data used for creating the first pass face, it is thought that the stacker does not overflow, and the sorting result of the first pass that paper sheets are uniformly stacked in the respective stackers is obtained.

As described above, the sorting apparatus according to the present embodiment acquires the result data indicating the numbers of past processing for the respective sorting information from the server 2, simulates the processing result of the sorting processing of the second pass using the acquired result data, and creates the first pass face based on the simulation result so that the numbers of stacking of the respective stackers are uniformalized in the sorting processing of the first pass. By this means, the sorting apparatus can reduce a possibility of overflow, and can reduce the working load of an operator even in the sorting processing of the first pass to perform sorting processing of the paper sheets with the sorting information undetermined.

While the embodiment of the present invention has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A sorting apparatus having a plurality of stackers in which paper sheets are stacked, the sorting apparatus comprising:
a first generation section which generates sorting result in which the paper sheets have been sorted in the plurality of stackers in a prescribed order, by a two-pass sorting processing of result data indicating the numbers of past processing for respective sorting information;
a second generation section which generates setting information of a sorting processing of a first pass in which the sorting information and the stackers are correlated, using the sorting result generated by the first generation section;
a discrimination section which discriminates sorting information of paper sheet to be processed; and
a sorting section which sorts the paper sheet whose sorting information has been discriminated by the discrimination section, in accordance with the setting information of the sorting processing of the first pass.

2. The sorting apparatus according to claim 1, further comprising:
a communication section which communicates with an external device; and
an acquisition section which acquires the result data for the respective sorting information from the external device via the communication section.

3. The sorting apparatus according to any of claim 1 or 2, wherein:
the second generation section generates the setting information in which the stackers in the sorting processing of the first pass are assigned, for stacking result of the respective stackers in the result of the two-pass sorting processing generated by the first generation section.

4. The sorting apparatus according to any one of claims 1 to 2, wherein:
the second generation section generates the setting information in which the stackers are assigned so that the numbers of stacking of the respective stackers are uniformalized in the sorting processing of the first pass for the result data.

5. The sorting apparatus according to any of claim 1 or 2, wherein:
the second generation section generates the setting information in which the plurality of stackers are assigned to the sorting information whose the number of processing of the result data is plural, in the sorting processing of the first pass.

6. A generating method of sorting setting information to be used in a sorting apparatus having a plurality of stackers in which paper sheets are stacked, which sorts the paper sheets based on setting information in which sorting information and the stackers are correlated, the generating method of sorting setting information comprising:
generating sorting result in which the paper sheets have been sorted in the plurality of stackers in a prescribed order, by a two-pass sorting processing of result data indicating the numbers of past processing for the respective sorting information; and
generating setting information of a sorting processing of a first pass, using the generated result of the two-pass sorting processing.

7. The generating method of sorting setting information according to claim 6, further comprising:
acquiring the result data for the respective sorting information from an external device.

8. The generating method of sorting setting information according to any of claim 6 or 7, wherein:
the setting information of the sorting processing of the first pass is generated, by assigning the stackers in the sorting processing of the first pass, for the stacking result of the respective stackers in the generated sorting result of the two-pass sorting processing.

9. The generating method of sorting setting information according to any one of claims 6 to 7, wherein:
the setting information of the sorting processing of the first pass is generated, by assigning the stackers to the sorting information so that the numbers of stacking of the respective stackers are uniformalized in the sorting processing of the first pass for the result data.

10. The generating method of sorting setting information according to any one of claims 6 to 7, wherein:
the setting information of the sorting processing of the first pass is generated, by assigning the plurality of stackers to the sorting information whose the number of processing of the result data is plural, in the sorting processing of the first pass.
